(19) United States
(12) Patent Application Publication
(10) Pub. No.: US 2024/0018046 A1
(43) Pub. Date: Jan. 18, 2024

(54) EARLY STRENGTH SLAG-BASED CEMENTITIOUS BINDER

(71) Applicant: GCP Applied Technologies Inc., Wilmington, MA (US)

(72) Inventors: Pierre Estephane, Stockport (GB); Elizabeth Burns, Windham, NH (US)

(21) Appl. No.: 18/029,753

(22) PCT Filed: Oct. 1, 2021
(86) PCT No.: PCT/US2021/053092

§ 371 Date: Mar. 31, 2023

Related U.S. Application Data
(60) Provisional application No. 63/086,627, filed on Oct. 2, 2020.

(51) Int. Cl. C04B 28/08; C04B 22/06; C04B 24/26; C04B 22/12; C04B 22/08; C04B 24/20; C04B 14/28

(52) U.S. Cl. CPC C04B 28/082; C04B 22/064; C04B 22/066; C04B 24/2647; C04B 22/124; C04B 22/085; C04B 24/20; C04B 14/28; C04B 2103/10

(57) ABSTRACT

The present invention provides exemplary method and additive for making cementitious binders that comprise primarily ground granulated blast furnace slag (GGBFS) having excellent strength at 24 hours, with preferably little or minimal amounts of Ordinary Portland Cement (OPC). As OPC manufacture involves carbon dioxide release into the atmosphere, the use of a GGBFS-based binder composition will help to enhance sustainability practices in the construction industry and minimizing strength losses implied by deletion of OPC. Strength in the GGBFS binder composition is enhanced by an alkaline-earth activator in combination with a strength enhancing component comprising dispersant and secondary activator.

### FIELD OF THE INVENTION

The invention relates to the field of hydratable cementitious compositions useful as construction materials, and more particularly to method and additive composition for achieving slag-based binder compositions having excellent strength despite zero or insignificant amounts of Portland cement (OPC).

### BACKGROUND OF THE INVENTION

Granulated blast furnace slag (GBFS) is obtained as a byproduct of the industrial steel manufacturing process. The ground form of GBFS is called ground granulated blast furnace slag (GGBFS). GGBFS is widely used for producing environmentally friendly construction materials. Significant attention has been paid to alkali-activated GGBFS (AAS) materials, which employ alkaline solutions to create a strong binder, as alternatives for replacing Ordinary Portland Cement (OPC). See e.g., Jeong et al., “Influence of Slag Characteristics on Development and Reaction Products in CaO-Activated Slag System,” Cement and Concrete Composites 72 (ELSEVIER 2016), pages 155-167 (2018).

Hydratable cementitious compositions which contain little to no amounts of Ordinary Portland Cement (“OPC” or “Portland cement”) are highly desirable from an environmental perspective because they avoid the large carbon dioxide emissions that arise from OPC manufacturing.

In United Kingdom Patent Application No. GB 2525705A, Ball et al taught an activator composition for non-OPC material comprising calcium oxide (CaO) or lime and a polycarboxylate-ether-based (hereinafter “PC”) superplasticizer. These were mixed with ground granulated blast furnace slag (GGBFS) and/or pulverized fuel ash (PFA) to provide a cementitious binder that did not contain OPC.

However, the major concern with hydratable compositions that employ large portions of slag and/or fly ash has been the relative lack of compressive strength as compared to cement (OPC).

To this point, it has been taught that certain alkanolamines could allow for substitution of cement using slag, fly ash, or other materials. See e.g., U.S. Pat. No. 4,990,190 of Myers et al. and U.S. Pat. No. 6,290,772 of Cheung et al. Conventional expectations are that up to 60% of cement could be replaced, and perhaps optimistically larger amounts up to 90% have been attempted.

In the wake of increasing awareness about global warming, the objective of using lower percent cement content or even OPC-free binder compositions is moving closer to the forefront of the consciousness of the concrete industry.

### SUMMARY OF THE INVENTION

The present invention provides exemplary methods and additive compositions for making cementitious materials comprising predominantly ground granulated blast furnace slag (GGBFS), an alkaline-earth activator, and early strength enhancer, having little or preferably no amount of cement (OPC) and nevertheless having e excellent strength at 24 hours.

A method for making a cementitious composition, comprising: mixing together with water the following components:
(A) a cementitious binder composition comprising ground granulated blast furnace slag (GGBFS) in an amount of 71%-100% based on total dry weight of the cementitious binder component (more preferably in the amount of 91%-100%, and most preferably 97%-100%);
(B) at least one alkaline-earth activator chosen from Ca(OH)₂, CaO, MgO, or a mixture thereof; and
(C) an early strength enhancer component comprising (i) at least one slag dispersant chosen from a polycarboxylate ether (PC) type polymer dispersant, a non-PC dispersant chosen from a sulfonate type dispersant (e.g., naphthalene sulfonate, melamine sulfonates, lignin sulfonates) or a phosphonate type dispersant; and (ii) at least one secondary activator chosen from calcium nitrate, calcium nitrite, calcium chloride, sodium chloride, triethanolamine, methyldiethanolamine, sodium thiocyanate or mixture thereof.

An exemplary admixture package of the present invention for modifying a ground granulated blast furnace slag (GGBFS) composition comprises:
(A) at least one alkaline-earth activator chosen from Ca(OH)₂, CaO, MgO, or a mixture thereof; and
(B) an early strength enhancer component comprising (i) at least one slag dispersant chosen from a polycarboxylate ether (PC) type polymer dispersant, a non-PC dispersant chosen from a sulfonate type dispersant (e.g., naphthalene sulfonate, melamine sulfonates, lignin sulfonates) or a phosphonate type dispersant; and (ii) at least one activator chosen from calcium nitrate, calcium nitrite, calcium chloride, sodium chloride, triethanolamine, methyldiethanolamine, sodium thiocyanate or mixture thereof.

In the exemplary admixture package described above, the at least one alkaline earth activator of component A can be packaged as a dry powder mix, which can be combined with a GGBFS-containing binder composition before, during, or after, the early strength enhancer component of component B is combined with the GGBFS-containing binder composition. Component B may be in the form of a liquid-dispensible admixture composition.

In other exemplary hydratable slag-based compositions of the invention, one or more supplementary cementitious materials may be combined into the GGBFS-based binder to enhance durability.

Further advantages and features of the invention will be described in further detail hereinafter.

### DETAILED DESCRIPTION OF EXEMPLARY EMBODIMENTS

The present inventors now turn to describing various exemplary embodiments of their invention, starting with various definitions of terms as used herein.

The term “Ordinary Portland cement” (OPC) as used herein includes hydratable cement which is produced by pulverizing clinker consisting of hydraulic calcium silicates and one or more forms of calcium sulfate (e.g., gypsum) as an interground additive.

The term “cementitious” as used herein refers to GGBFS-containing materials that function, when mixed with water, to bind together fine aggregates (e.g., sand), coarse aggregates (e.g., crushed gravel), or mixtures thereof. The terms “cementitious” and “binder” may be used together herein, or even interchangeably, to signify a material that hardens when mixed with an amount of water sufficient to initiate hardening processes within the material and attain binding together of aggregates into a hardened mass or structure. The term “cementitious” refers to cement-like qualities but does not require or forbid the presence of Portland cement (OPC) within the binder composition.

Exemplary embodiments of the present invention will involve very low OPC levels, and most preferably no OPC whatsoever. In exemplary embodiments of the present invention, “cementitious” and “binder” will refer to compositions comprising predominantly ground granulated blast furnace slag (GGBFS) as well as GGBFS when used with supplemental cementitious binder materials.

Unless otherwise indicated, percentages of components will be expressed herein with regard to total dry weight of GGBFS-containing cementitious binder composition including any supplemental cementitious materials and admixtures.

The term “hydratable” as used herein is intended to refer to cementitious and/or binder materials that are hardened by chemical interaction with water.

Preferred exemplary embodiments of the present invention comprise hydratable cementitious compositions that are made from activated ground granulated blast furnace slag (GGBFS), optionally with fly ash, and minimal OPC cement (i.e., no more than 4% by dry weight of total binder); and, more preferably, no more than 2% by dry weight of total binder); and, most preferably, zero amount of cement (OPC).

In exemplary embodiments, a strength enhancing component will be used. At least one dispersant will be used for strength enhancement of the slag-based binder composition in accordance with in exemplary methods, additive compositions, and slag-based cementitious compositions of the present invention. An example dispersant may comprise at least one polycarboxylate ether type polymer dispersant (hereinafter “PC” or “PCE” polymer); at least one non-PC dispersant such as sulfonate or phosphonate type dispersants; or a mixture of PC and non-PC type dispersants.

An example non-PC type dispersant comprises known hydraulic cement dispersants chosen from sodium naphthalene sulfonate, melamine sulfonate, and lignin sulfonate. Such dispersants are commonly used in the cement industry. Sodium, potassium and calcium salts of these types of non-PC dispersants are commonly used in formulations.

Exemplary non-PC type dispersants can also include carbohydrates such as gluconic acid and its salts.

Preferred dispersants contemplated for use in the strength enhancement component include polycarboxylate ether type polymer dispersants (known as “PC” or “PCE” type polymers) which have proven to be powerful dispersants for hydraulic binders. These are well-discussed in the literature. See e.g., Jeknavorian, A. A., Concrete International, October 2019, page 49; See also Plank, J.; Sakai, E.; Miao, C. W.; Yu, C.; Hong, J. X.; Cement and Concrete Research, 2015, issue 78, pages 81-99). Such PC type dispersant polymers are commercially available in a wide variety of structures, and typically made of two monomer units (A+B type) or even from three or more monomer units (A+B+C type) which contain double bonds for radical polymerization. Such PC type dispersant polymers are sometimes referred to as “comb type” PC polymers as they contain oxyalkylene-containing groups connected by ether linkage to a carbon backbone.

In exemplary embodiments of the present invention, a PC type polymer dispersant may be used which contains at least monomers A and B as discussed below, and further exemplary embodiments may employ at least two PC type polymers wherein a first polymer was formed from monomers A and B, while a second polymer was formed from monomers A, B, and C.

Thus, exemplary monomer component A for a PC type polymer comprises an unsaturated carboxylic acid monomer represented by structural formula 1, wherein R¹, R², R³, each represent a hydrogen atom, a C1 to C4 alkyl group, or —COOM group wherein M represents a hydrogen atom or an alkali metal, and example monomers may include acrylic acid, methacrylic acid, maleic acid, fumaric acid, or itaconic acid

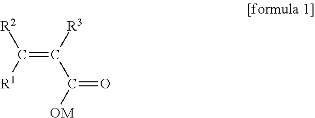

Exemplary component monomer B for forming an example PC type polymer dispersant, is represented by formula 2 below, and contributes two carbons to the backbone of the polymer and is often called a macromonomer or macromer as it may itself be a polymer or copolymer. The macromonomer comprises a polyalkylene oxide chain of molecular weight from 200 to 5000 daltons, more commonly 500 to 3000 daltons, and a polymerizable double bond. The polyalkylene oxide is often polyethylene oxide (PEO) as it contains many ethylene oxide (EO) groups, although other alkylene oxides, such as propylene oxide (PO) can be included in the macromer. The link between the polymerizable double bond and the polyalkylene oxide can be an ester—the PEO ester of methacrylic acid, for example—or an ether linkage such as in an allyl, methallyl, butyl, or isoprenyl ether. A mixture of macromere can be advantageously used, such as taught in U.S. Pat. No. 10,047,008 of L. Kuo (owned by the common assignee hereof). Component B is represented by formula 2, wherein R⁵, R⁶, and R⁷ each individually represent a hydrogen atom, a C1 to C4 alkyl group, or —COOM group wherein M represents a hydrogen atom or an alkali metal; Y represents —(CH₂)ₚ— wherein “p” represents an integer of 0 to 6; Z represents —O—, —COO—, —OCO—, —COHN—, or —NHCO— group; -(AO)ₙ represents repeating alkylene oxide groups such as ethylene oxide groups, propylene oxide groups, butylene oxide groups, or a mixture thereof; “n” represents the average number of repeating -(AO)-groups and is an integer of from 10 to 250:

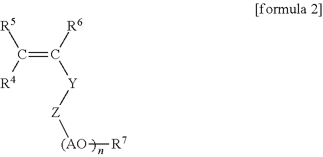

In example PC type dispersant polymer useful in the present invention, the ratio of monomer A to monomer B is typically 5:1 to 1:1, and more preferably 4:1 to 2:1.

Other exemplary PC type dispersant polymers can further include a component monomer C which is preferably hydrolysable such that it functions to provide the polymer with dispersing properties after the binder composition is hydrated upon mixing with water. An example monomer C is represented by structural formula 3 below, in which R⁸, R⁹, and R¹⁰ each individually represent a hydrogen atom, a C1 to C4 alkyl group, or —COOM group wherein M represents a hydrogen atom or an alkali metal; W represents an oxygen atom or an —NH— group, and R₁₁ represents a C1-C10 alkyl group or a C2-C10 hydroxyalkyl group (e.g., methyl methacrylate, propyl methacrylate, or other acrylate).

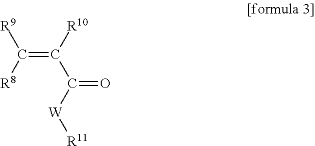

Example PC type dispersant polymers, similar to the one described above, is disclosed in the patent literature. E.g., U.S. Pat. No. 8,070,875 of Jeknavorian et al. (owned by the common assignee hereof).

Preferred ratios of monomer A to monomer C (A:C) are in the range of from 1:10 to 5:1; more preferably in the range of 2:1 to 1:2. Preferred ratios of monomer A plus monomer C to monomer B (A+C:B) are typically 5:1 to 1:1; and more preferably in the range of 4:1 to 2:1.

Other exemplary dispersants which are believed to be suitable for use in enhancing strength of slag-based cementitious binder composition can include other structures, such as phosphonate containing materials. See e.g., U.S. Pat. No. 8,058,337 of Goz-Maciejewska et al. (owned by the common assignee hereof) and US Publication 2019/0010090 of Kraus et al.

In combination with or as part of the strength enhancement component, the present inventors believe that certain admixtures can be used in conjunction with PC-type polymer dispersants to obtain additional benefits, such as using at least one defoamer, viscosity modifying agent, biocide, or mixture thereof. Hence, exemplary embodiments described herein may optionally be used with one or more of such additional admixture components.

Example defoamers contemplated for use in the slag-based compositions of the invention may include conventional defoamers used in concrete admixtures. These are usually hydrophobic with low HLB values and poor water solubility. Examples include mineral oil based defoaming agents (e.g., kerosene, liquid paraffin); oil-and-fat type defoaming agents (e.g., animal and plant oils, sesame oil, castor oil, and their alkylene oxide adducts); fatty acid based ester defoaming agents (e.g., oleic acid, stearic add and their alkylene oxide adducts); fatty acid ester based defoaming agents (e.g., glycerol monoricinolate, alkenyl succinic acid derivatives, sorbitol monolaurate, sorbitol trioleate, natural wax); oxyalkylene base defoaming agents (e.g., block and random copolymers of poly(oxyethylene) and poly(oxypropylene) such as PLURONIC™ materials of BASF; (poly)oxyalkyl ethers (e.g., diethylene glycol heptyl ether, polyoxyethylene oleyl ether, polyoxypropylene butyl ether, polyoxyethylene polyoxypropylene 2-ethylhexyl ether, and adducts of oxyethylene oxypropylene to higher alcohols with 12 to 14 carbon atoms); (poly)oxyalkylene (alkyl) aryl ethers (e.g., polyoxypropylene phenyl ether and polyoxyethylene nonyl phenyl ether; acetylene ethers as formed by addition polymerization of alkylene oxide to acetylene alcohols such as 2,4,7,9-tetramethyl-5-decyne-4,7-diol, 2,5-dimethyl-3-hexyne-2,5-diol, and 3-methyl-1-butyn-3-ol; (poly)oxyalkylene fatty acid esters such as diethylene glycol oleic acid ester, diethylene glycol lauric acid ester, and ethylene glycol distearic acid); (poly)oxyalkylene sorbitan fatty acid esters (e.g., (poly)oxyethylene sorbitan monolauric acid ester, (poly)oxyethylene sorbitan trioleic acid ester); (poly)oxyalkylene alkyl (aryl) ether sulfuric acid ester salts (e.g., sodium polyoxypropylene methyl ether sulfate, sodium polyoxyethylene dodecylphenol ether sulfate); (poly)oxyalkylene alkyl phosphoric acid esters (e.g., (poly)oxyethylene stearyl phosphate); (poly)oxyalkylene alkylamines (e.g., polyoxyethylene laurylamine; and polyoxyalkylene amide); alcohol base defoaming agents (e.g., octyl alcohol, hexadecyl alcohol, acetylene alcohol, and glycols); amide base defoaming agents (e.g., acrylate polyamines); phosphoric acid ester base defoaming agents (e.g., tributyl phosphate and sodium octyl phosphate); metal soap base defoaming agents (e.g., aluminum stearate and calcium oleate); and silicone base defoaming agents (e.g., dimethyl silicone oils, silicone pastes, silicone emulsions, organic-denatured polysiloxanes).

As mentioned above, dispersants such as PC type polymer dispersants may also be used in combination with viscosity modify agents (VMA). Example VMAs include gums such as welan gum, zanthan gum, guar gum and diutan gum. Other example VMAs include cellulose ethers such as hydroxypropyl cellulose, which are commercially available in a wide variety of molecular weights and structures. For example, METHOCEL® modified cellulose thickeners from Dow, or METOLOSE® thickeners from Shin-Etsu. Use of these materials with polycarboxylate ethers is disclosed in WO20180715259A1.

The inventors describe the invention using various example embodiments, and various exemplary aspects of those example embodiments, as follows.

In a first exemplary embodiment, the invention provides a method for making a cementitious composition, comprising: mixing together with water the following components:
(A) a cementitious binder composition comprising ground granulated blast furnace slag (GGBFS) in an amount of 71%-100% based on total dry weight of the cementitious binder component (more preferably in the amount of 91%-100%, and most preferably 97%-100%);
(B) at least one alkaline-earth activator chosen from Ca(OH)₂, CaO, MgO, or a mixture thereof; and
(C) an early strength enhancer component comprising (i) at least one slag dispersant chosen from a polycarboxylate ether (PC) type polymer dispersant, a non-PC dispersant chosen from a sulfonate type dispersant (e.g., naphthalene sulfonate, melamine sulfonates, lignin sulfonates) or a phosphonate type dispersant; and (ii) at least one secondary activator chosen from calcium nitrate, calcium nitrite, calcium chloride, sodium chloride, triethanolamine, methyldiethanolamine, sodium thiocyanate, or a mixture thereof.

In a first aspect of the first embodiment, a PC type polymer dispersant may be used in combination with a non-PCT type dispersant, such as a lignosulfonate, naphthalene sulfonate, or melamine sulfonate.

In a second aspect of the first embodiment, the secondary activator comprises calcium nitrate and sodium thiocyanate.

In a third aspect of the first embodiment, the secondary activator comprises calcium nitrate and methyldiethanolamine.

In a fourth aspect of the first embodiment, the secondary activator comprises calcium nitrate and calcium chloride.

In a second exemplary embodiment that may be based on the first exemplary embodiment above, the early strength enhancer component comprises at least one PC type polymer dispersant, and more preferably at least two PC type polymer dispersants.

In a first aspect of the second exemplary embodiment, the early strength enhancer component comprises at least one PC type polymer dispersant having two different average size alkylene oxide groups.

In a second aspect of the second exemplary embodiment, the early strength enhancer component comprises at least two PC type dispersant polymers wherein a first PC polymer has an initial slump enhancing property and a second PC polymer has a slump retaining property.

In a third aspect of the second exemplary embodiment, the early strength enhancer component comprises at least two PC type dispersant polymers having different initial slump enhancing property or different slump retaining property, and are used in further combination with a VMA, defoamer, or mixture thereof.

In a fourth aspect of the second exemplary embodiment, the early strength enhancer component comprises at least one PC and a defoamer selected from (poly)oxyalkylene alkylamines, acetylene ethers as formed by addition polymerization of alkylene oxide to acetylene alcohols such as 2,4,7,9-tetramethyl-5-decyne-4,7-diol, 2,5-dimethyl-3-hexyne-2,5-diol, and 3-methyl-1-butyn-3-ol and phosphoric acid ester base defoaming agents.

In a fifth aspect of the second exemplary embodiment, the early strength enhancer component comprises at least one PC, at least one gum (e.g., welan gum, xanthan gum, guar gum, diutan gum) and at least one cellulose ether (e.g., hydroxypropyl cellulose).

In a third exemplary embodiment that may be based on any of the first through second exemplary embodiments above, the binder composition of component A further comprises fly ash, wherein the GGBFS:fly ash weight ratio in component A is from 71:29 to 95:5.

In a fourth exemplary embodiment that may be based on any of the first through third exemplary embodiments above, the water and the components A, B, and C are mixed together in the following amounts: water in the amount of 25%-45%; component A comprising 71%-100% GGBFS based on total dry solid weight of the cementitious binder composition of component A; component B in the amount of 0.5% to 10%; and component C in the amount of 1.5% to 6.0%; the foregoing percentages of water and components A, B, and C being based on total dry weight of component A.

In a fifth exemplary embodiment that may be based on any of the first through fourth exemplary embodiments above, the water and components A, B, and C are mixed together in the following amounts: water in the amount of 25%-40%; component A comprising 96%-100% GGBFS based on total dry solids weight of the cementitious binder composition of component A; component B in the amount of 2.0% to 8.0%; and component C in the amount of 2.0% to 5.0%; the foregoing percentages of water and components A, B, and C being based on total dry weight of component A.

In a sixth exemplary embodiment that may be based on any of the first through fifth exemplary embodiments above, the water and components A, B, and C are mixed together in the following amounts: water in the amount of 28%-38%; component A comprising 100% GGBFS based on total dry solids weight of the cementitious binder composition of component A; component B in the amount of 4.0% to 6.0%; and component C in the amount of 2.5% to 4.5%; the foregoing percentages of water and components A, B, and C being based on total dry weight of component A.

In a seventh exemplary embodiment that may be based on any of the first through sixth exemplary embodiments above, the components B and C are combined together or combined separately with component A. In a first aspect of this embodiment, component A may be supplied in the form of a powder, while component B may be supplied in the form of a liquid product.

In an eighth exemplary embodiment that may be based on any of the first through seventh exemplary embodiments above, the invention includes additional components that may be included in making the cementitious composition. In addition to using at least one alkaline-earth activator component chosen from Ca(OH)₂, CaO, MgO, or a mixture thereof as set forth in component B, component A is combined with at least two activators chosen from calcium nitrate, calcium nitrite, sodium thiocyanate, triethanolamine, methyldiethanolamine, calcium chloride, sodium chloride, or mixture thereof.

In a first aspect of the eighth exemplary embodiment, at least one of the following components may be combined into or mixed with the GGBFS-containing binder composition, and various combinations of these components may also be used together. The preferred amounts are expressed as percentage weight based on total dry weight of the GGBFS-containing binder composition of component A: calcium nitrate (preferably 0.9%-4.9%, more preferably 1.4%-4.1%, most preferably 1.8%-3.7%); calcium nitrite (preferably 0.02%-0.12%, more preferably 0.03%-0.09%, most preferably 0.04-0.08%); sodium thiocyanate (preferably 0.06%-0.3%, more preferably most preferably 0.1%-0.2%); triethanolamine (preferably 0.02%-0.12%, more preferably 0.03%-0.09%, most preferably 0.04%-0.08%); methyldiethanolamine (preferably 0.01%-0.06%, more preferably 0.02%-0.05%, most preferably 0.02% -0.04%); calcium chloride (preferably 0.9% -4.9%, more preferably 1.4% -4.1%, most preferably 1.8% -3.7%); and sodium chloride (preferably 0.9% -4.9%, more preferably 1.4% -4.1%, most preferably 1.8% -3.7%).

In a second aspect of the eighth exemplary embodiment, the preferred amounts expressed as percentage weight based on total dry weight of the GGBFS-containing binder composition of component A are: calcium nitrate (preferably 0.9%-4.9%, more preferably 1.4%-4.1%, most preferably 1.8%-3.7%) and sodium thiocyanate (preferably 0.06%-0.3%, more preferably 0.08%-0.24%, most preferably 0.1%-0.2%).

In a third aspect of the eighth exemplary embodiment, the preferred amounts expressed as percentage weight based on total dry weight of the GGBFS-containing binder composition of component A are: calcium nitrate (preferably 0.9%-4.9%, more preferably 1.4%-4.1%, most preferably 1.8%-3.7%) and methyldiethanolamine (preferably 0.01%-0.06%, more preferably 0.02%-0.05%, most preferably 0.02% -0.04%)/

[symbol]

In a fourth aspect of the eighth exemplary embodiment, the preferred amounts expressed as percentage weight based on total dry weight of the GGBFS-containing binder composition of component A are: calcium nitrate (preferably 0.9%-4.9%, more preferably 1.4%-4.1%, most preferably 1.8%-3.7%) and calcium chloride (preferably 0.9% -4.9%, more preferably 1.4% -4.1%, most preferably 1.8% -3.7%);

In a ninth exemplary embodiment that may be based on any of the first through eighth exemplary embodiments above, the GGBFS-containing component A is combined with at least one activator chosen from calcium nitrate, calcium nitrite, or mixture thereof.

In a first aspect of this ninth exemplary embodiment, the at least one activator comprises both calcium nitrate and calcium nitrite.

In a tenth exemplary embodiment that may be based on any of the first through ninth exemplary embodiments above, the GGBFS-containing cementitious binder of component A is devoid of Ordinary Portland Cement, calcium sulfoaluminate cement, or mixture thereof.

In an eleventh exemplary embodiment that may be based on any of the first through tenth exemplary embodiments above, the strength enhancement component comprises at least one PC type dispersant polymer obtained from three monomer components A, B, and C, wherein monomer component A is an unsaturated carboxylic acid monomer represented by structural formula 1,

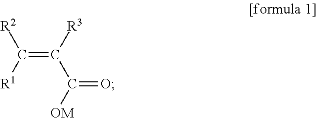

monomer component B is a polyoxyalkylene monomer represented by structural formula 2:

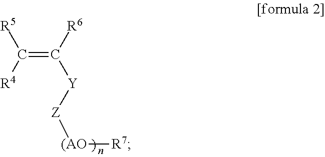

monomer component C is an unsaturated carboxylate ester or amide monomer represented by structural formula 3:

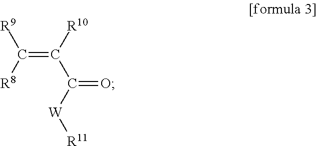

wherein R¹, R², R³, R⁴, R⁵, R⁶, R⁷, R⁸, R⁹, and R¹⁰ each individually represent a hydrogen atom, a C1 to C4 alkyl group, or —COOM group wherein M represents a hydrogen atom or an alkali metal; Y represents —(CH₂)ₚ— wherein “p” represents an integer of 0 to 6; Z represents —O—, —COO—, —OCO—, —COHN—, or —NHCO— group; -(AO)ₙ represents repeating ethylene oxide groups, propylene oxide groups, butylene oxide groups, or a mixture thereof; “n” represents the average number of repeating -(AO)-groups and is an integer of from 10 to 250; W represents an oxygen atom or an —NH— group, and R₁₁ represents a C1-C10 alkyl group or a C2-C10 hydroxyalkyl group.

In a twelfth exemplary embodiment that may be based on any of the first through eleventh exemplary embodiments above, the strength enhancement component comprises at least one polycarboxylate ether type dispersant polymer having at least two different structures using different component B monomers represented by formula 2.

In a first aspect of the twelfth example embodiment, exemplary PC dispersant polymers may have different monomer component B groups (formula 2). Example PC polymers may have alkylene oxide (AO) groups of different lengths (see e.g., U.S. Pat. No. 10,047,008). For example, the PC polymer may comprise a structure wherein AO groups as defined in formula 1 may have different sizes on the polymer structure, e.g., such as for one AO group wherein the integer “n” is in the range of 8-25, and also for another AO group wherein the integer “n” is in the range of 20-100. As the polymer is of the “comb” type, it may be said that the comb has mixed (and relatively small) “teeth” comprised of different sized AO groups. As an alternative embodiment, at least two or more PC polymers can be used each having AO groups that are different as between the two or more PC polymers.

In a thirteen exemplary embodiment that may be based on any of the first through twelfth exemplary embodiments above, the early strength enhancement component comprises at least one polycarboxylate type comb polymer in combination with at least one viscosity modifying admixture (VMA), preferably chosen from a biopolymer polysaccharide (e.g., diutan gum, welan gum, xanthan gum), a cellulose type thickener (e.g., a methyl cellulose thickener or other cellulose type thickener modified for improved water miscibility or compatibility), or mixture thereof.

In a first aspect of this thirteenth exemplary embodiment, the early strength enhancement component may comprise at least two PC dispersant polymers, and at least one further component chosen from a VMA, a defoamer agent, or mixture thereof.

In a fourteenth exemplary embodiment that may be based on any of the first through thirteenth exemplary embodiments above, the strength enhancement component comprises a non-PC dispersant, such as sodium naphthalene sulfonate.

In a fifteenth exemplary embodiment that may be based on any of the first through fourteenth exemplary embodiments above, the at least one alkaline-earth activator of component B further includes calcium carbonate or source of calcium carbonate, and wherein the calcium carbonate is present in the binder composition of component A in the amount of 0.1 to 10% based on total dry weight of component A.

In a first aspect of this fifteenth exemplary embodiment, the at least one alkaline-earth activator of component B further comprises a limestone or limestone filler.

In a sixteenth exemplary embodiment that may be based on any of the first through fifteenth exemplary embodiments above, the method of forming a cementitious composition may further comprise, after mixing water and components A, B, and C together to obtain a uniform paste or slurry, subjecting the paste or slurry to a temperature of 30-70 degrees C.

In a seventeenth exemplary embodiment, the invention provides a cementitious composition made in accordance with any of the foregoing first through sixteenth exemplary embodiments above. The cementitious composition may be combined with aggregates to form concrete or mortar structures.

In an eighteenth exemplary embodiment, the invention provides An admixture package (e.g., components A and B contained in separate containers but sold as a two-component product or system) for modifying a ground granulated blast furnace slag (GGBFS) binder composition, comprising:
(A) at least one alkaline-earth activator chosen from Ca(OH)₂, CaO, MgO, or a mixture thereof; and
(B) an early strength enhancer component comprising (i) at least one slag dispersant chosen from a polycarboxylate ether (PC) type polymer dispersant, a non-PC dispersant chosen from a sulfonate type dispersant (e.g., naphthalene sulfonate, melamine sulfonates, lignin sulfonates) or a phosphonate type dispersant; and (ii) at least one activator chosen from calcium nitrate, calcium nitrite, calcium chloride, sodium chloride, triethanolamine, methyldiethanolamine, sodium thiocyanate or mixture thereof; and (iii) at least one secondary activator chosen from calcium nitrate, calcium nitrite, calcium chloride, sodium chloride, triethanolamine, methyldiethanolamine, sodium thiocyanate, or a mixture thereof. (The secondary activator should be different from the first activator).

In a first aspect of the eighteenth exemplary embodiment, the invention provides an admixture package, wherein the at least one alkaline earth activator of component A (e.g., Ca(OH)₂, CaO, MgO, or mixture) can be packaged as a dry powder mix, and this can be combined with a GGBFS-containing binder composition before, during, or after the early strength enhancer component of component B is combined with the GGBFS-containing binder composition. Component B may be in the form of a liquid-dispensable admixture composition.

In a second aspect, either or both of the components A and B can include further admixture components, such as defoamer(s), viscosity modifying agent(s), biocide, lime (e.g., hydrated), or mixtures thereof.

In a third aspect of the eighteenth exemplary embodiment, the invention provides an admixture package, wherein the early strength enhancer component comprises (i) at least one slag dispersant chosen from a polycarboxylate ether (PC) type polymer dispersant, a non-PC dispersant chosen from a sulfonate type dispersant (e.g., naphthalene sulfonate, melamine sulfonates, lignin sulfonates) or a phosphonate type dispersant; and (ii) at least one activator (and alternatively at least two or more) chosen from calcium nitrate, calcium nitrite, calcium chloride, sodium chloride, triethanolamine, methyldiethanolamine, sodium thiocyanate or mixture thereof is introduced into a concrete mix load as contained in the rotatable mixer drum of a concrete delivery truck, either at the batch plant or at the construction site where the concrete mix is delivered and placed.

For example, the early strength enhancer component may be admixed into a slag-based binder composition contained in a truck mixer drum, such as at a construction site where the binder composition is to be cast, poured, pumped, sprayed, or otherwise applied into place, by using an automated concrete slump monitoring system. The one or more alkaline-earth activators chosen from Ca(OH)₂, CaO, MgO, or a mixture thereof are preferably added into the slag load contained in the truck at the batching plant, or otherwise added into the truck mixer drum at some other location either before or after addition of early strength enhancer component.

Automated slump monitoring systems suitable for addition of chemicals during mixing, transit, and/or at delivery, are commercially available from GCP Applied Technologies Inc., Cambridge, Massachusetts (USA) under the VERIFI® trade name. These systems monitor fluid admixture mixing into the concrete load and are suitable for confirming when uniform mixing is accomplished. The VERIFI® Systems employ hydraulic pressure sensors which allow for sampling numerous times throughout the rotation of the mixer drum. (See e.g., U.S. Pat. Nos. 8,020,431; 8,118,473; 8,311,678; 8,491,717; 8,727,604; 8,746,954; 8,764,273; 8,818,561; 8,989,905; 9,466,803; 9,550,312; PCT/US2015/025054 (Publ. No. WO 2015/160610 A1); and PCT/US2014/065709 (Publ. No. WO02015073825 A1)). Alternatively, the monitoring system may be based on use of a force sensor mounted within the mixer drum. See e.g., U.S. Pat. Nos. 8,848,061 and 9,625,891 of Berman (owned by the common assignee hereof), U.S. Pat. No. 9,199,391 of Denis Beaupre et al. (Command Alkon Inc.), or US Publication No. 2009/0171595 and WO 2007/060272 of Benegas.

In a fourth aspect of the eighteenth example embodiment, the invention provides an admixture package, wherein at least one slag dispersant is a polycarboxylate ether (PC) type polymer dispersant, or a non-PC dispersant chosen from sulfonate type dispersant (e.g., naphthalene sulfonate, melamine sulfonates, lignin sulfonates) or phosphonate type dispersant. This example admixture package allows for introduction of the dispersant into the concrete mix contained in a truck mixer drum at the site by using an automated concrete slump monitoring system. The at least one alkaline-earth activator (e.g., Ca(OH)₂, CaO, MgO or a mixture thereof) and at least one activator (and alternatively two or more) chosen from calcium nitrate, calcium nitrite, calcium chloride, sodium chloride, triethanolamine, methyldiethanolamine, sodium thiocyanate or mixture thereof may be incorporated into the concrete mix load at the batch plant or other location.

In a nineteenth exemplary embodiment, the invention provides a package system for making a cementitious composition with little or no OPC content, comprising: at least two separately packaged components A and B wherein
(A) Component A comprises a cementitious binder composition comprising ground granulated blast furnace slag (GGBFS) in an amount of 71%-100% based on total dry weight of the cementitious binder component (more preferably in the amount of 91%-100%, and most preferably 97%-100%), the cementitious binder composition being packaged separately from component B;
(B) Component B comprises multiple component parts (wherein in some exemplary embodiments some of which may be housed in separate containers):
   (i) at least one alkaline-earth activator chosen from Ca(OH)₂, CaO, MgO, or a mixture thereof;
   (ii) at least one slag dispersant chosen from a polycarboxylate ether (PC) type polymer dispersant, a non-PC dispersant chosen from a sulfonate type dispersant (e.g., naphthalene sulfonate, melamine sulfonates, lignin sulfonates) or a phosphonate type dispersant; and
   (iii) at least one secondary activator chosen from calcium nitrate, calcium nitrite, calcium chloride, sodium chloride, triethanolamine, methyldiethanolamine, sodium thiocyanate or mixture thereof.

As was described in various aspects for the preceding example embodiment, the at least one dispersant and at least one secondary activator may be introduced into the concrete mix load in a delivery truck mixer drum, while the at least one alkaline-earth activator is introduced at the batch plant or other location.

While the invention is described herein using a limited number of exemplary embodiments, these specific embodiments are not intended to limit the scope of the invention as otherwise described and claimed herein. Modification and variations from the example embodiments exist. Further specific examples are given to illustrate the claimed invention. It should be understood that the invention is not limited to the specific details set forth in the examples. All parts and percentages in the examples, as well as in the remainder of the specification, are by percentage weight unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k*(RU−RL), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above, is also specifically disclosed.

### EXEMPLIFICATIONS

### Comparative Examples 1, 2, 3 and 4

The current state of the art is illustrated through Comparative Examples 1-4. In each case, a mortar mix was prepared, using the ratios tabulated below, as follows. First, water was placed into mixing bowl, followed by liquid additives which were mixed manually into the water, followed by powders (e.g., GGBFS, Lime, fillers, etc.). These materials were mixed for 30 seconds in a mixer having a blade that rotated axially in a planetary motion at a speed of 60 rpm. Then 1350 grams of standard CEN sand was added into the mix over the next 30 seconds, during which mixing was continued for an additional 4 minutes. In total, this mixing procedure required about 5 minutes. During preparation, mixing, and testing, the mortar mix was kept at a temperature of about 24.0° C.±2.0° C.

The flow of the hydraulic cement mortar was tested according to the procedure described in ASTM C1437 using a flow mold. The mold was filled with mortar, lifted to release the mortar so that it flowed across the horizontal surface; and the diameter of the spreading of the released mortar was recorded as it slumped down from its original height defined by the mold. The mortar was then cast into prisms, having 40*40*160 mm dimensions, and the mortar was demolded after 24 hours, then 24-hour and 28-day compressive strength testing was performed.

In this first example, the inventor evaluated slow early strength gain where GGBFS is predominantly used in the cementitious mixture. All trials were done at water to binder ratio of 0.34, and Sodium Naphthalene Sulfonate Formaldehyde Condensate was used as a high range water reducer in the mortar mixes. Results are shown in below Table 1. Component weights are set forth in gram units.

In Comparative Example 1, the compressive strength at 24 hours of a mortar mix using only 700 g of GGBFS I was extremely low of 0.62 MPa. It was observed that this specimen was still wet after one day.

In Comparative Example 2, 10% of the GGBFS is replaced by CEM I; the compressive strength at 24 hours reached 4.0 MPa.

In Comparative Examples 3 and 4, in mixes of 700 g GGBFS and with the introduction of non-chloride-based activator or sodium chloride or calcium chloride, the GGBFS mix did not appear to set properly at 24 hours. Compressive strength was measured to be about 1.0 MPa in either case.

TABLE 1
Comparative Examples

| | Comparative | Comparative | Comparative | Comparative |
|---|---|---|---|---|
| Component | Example 1 | Example 2 | Example 3 | Example 4 |
| GGBFS I, grams | 700 | 630 | 700 | 700 |
| CEN Sand, grams | 1350 | 1350 | 1350 | 1350 |
| Water/Binder ratio | 0.34 | 0.34 | 0.34 | 0.34 |
| NSFC, % solids by weight of | 0.2 | 0.3 | 0.2 | 0.27 |
| binder | | | | |
| CEM \| 42.5R, grams | — | 70 | — | — |
| Secondary Activator(s), % | — | — | 1.16 | — |
| wt solids binder | | | | |
| CaCl₂, % wt solids binder | — | — | — | 2.52 |
| Flow, mm | 190 | 185 | 130 | 200 |
| Density, kg/m3 (kilograms | 2278 | 2280 | 2264 | 2287 |
| per cubic meter) | | | | |
| Compressive Strength, 24 | 0.62 | 4.00 | 1.16 | 0.91 |
| hours, MPa | | | | |

It is noted that in comparative examples and inventive examples (embodiments of the invention) set forth in these Examples, the composition of the “Secondary Activator” was calcium nitrate at 20.0-50.0%; sodium thiocyanate at 2.0-5.0%, calcium nitrite at 0.5-5.0%, methyldiethanolamine at 0.1-2.0%, triethanolamine at 0.1-2.0%, mixed into water which can be in the amount of 36-79.1%, all percentages based on total weight of the Secondary Activator in liquid form. If sodium chloride or calcium chloride was used separately with one of the foregoing, these were separately listed (as it may be desirable in certain applications to avoid use of these salts). It is believed that the “Secondary Activator” could also function using just one or two of the agents identified above.

### Comparative Example 5 and Inventive Examples 6 and 7

The same mixing procedure used for Comparative Examples 1-4 was used, except that the material amounts of Table 2 were used. Table 2 shows the results of Comparative Example 5, and Inventive Examples 6 and 7. Comparative Example 5 is based on a sample made in accordance with patent GB 2525705A which mentions the use of an activator of component C. The component C activator will have a cumulative influence on early age compressive strength as well as on 28 days compressive strength.

In Comparative Example 5, in which the sample was made in accordance with the teachings of GB 2525705A, the average compressive strength of the specimens as tested at 24 hours as 1.8 MPa. Specimens were weak and friable in hand.

Inventive Example 6 includes the addition of a non-chloride activator at 2.1 percentage by weight of binder and resulted early strength reached 5.9 MPa at 24 hours and reached 45.6 MPa at 28 days. The difference of 20.0 MPa in compressive strength between Comparative Example 5 and Inventive Example 6 is remarkable.

Inventive Example 7 includes a chloride-based activator at 4.2% by weight of binder. The compressive strength of the sample increased to 9.7 MPa at 24 hours.

TABLE 2

| | Compar- | Inven- | Inven- |
|---|---|---|---|
| | ative | tive | tive |
| | Example | Example | Example |
| Component | 5 | 6 | 7 |
| GGBFS, grams | 770 | 770 | 770 |
| CEN Sand, grams | 1346.15 | 1346.15 | 1346.15 |
| Water/Binder ratio | 0.3 | 0.3 | 0.3 |
| Poly carboxylate, % wt. solids binder | 0.18 | 0.17 | 0.19 |
| Secondary Activator, % wt solids | 0 | 2.1 | 0 |
| binder | | | |
| NaCl powder, % wt solids binder | 0 | 0 | 4.2 |
| Hydrated Lime, grams | 3.85 | 3.85 | 3.85 |
| Flow, mm | 310 | 315 | 320 |
| Compressive Strength, 24 hours, Mpa | 1.8 | 5.9 | 9.7 |
| Compressive Strength, 28 days, Mpa | 25.3 | 45.6 | 30.9 |

The exemplary compositions made in Inventive Examples 6 and Inventive Examples 7 had significantly more compressive strength than the compositions made in Comparative Examples summarized in Table 1, as well as surprisingly more strength as compared to the compositions summarized in Example 5, Table 2.

### Inventive Example 8

The same mixing procedure used for Comparative Examples 1-4 was used, except the material amounts of Table 3 were used. In this example, Fly Ash was introduced into the mortar sample in an amount of up to 25.0% based on weight of total binders. Hydrated Lime was used at a dosage of 6.5% by weight of total binder content. Table 3 shows the results of Inventive Example 8, and suggest that the exemplary approaches of the invention can be applied to GGBFS containing fly-ash.

TABLE 3

| Component | Inventive Example 8 |
|---|---|
| GGBFS, grams | 577.5 |
| Fly Ash, grams | 192.5 |
| CEN Sand, grams | 1300 |
| Water/Binder ratio | 0.28 |
| PC, % solids by weight of binder | 0.26 |
| Secondary Activator, % wt solids binder | 2.1 |
| NaCl % wt solids binder | 0 |
| Hydrated Lime, grams | 50 |
| Flow, mm | 340 |
| Compressive Strength, 24 hours, Mpa | 4.3 |
| Compressive Strength, 28 days, Mpa | 47.8 |

In Test 8, in the presence of a non-chloride activator used in an amount of up to 2.1% by weight based on total binders, the specimens measured an average of 4.3 MPa compressive strength at 24 hours and of 47.8 MPa compressive strength at 28 days, a very good result viewed in light of the comparative examples.

### Inventive Examples 9-14

The same mixing procedure used for Comparative Examples 1-4 was used, except the material amounts of Table 4 were used. In this example, all the trials were conducted at a water-to-binder ratio of 0.34 to 0.37. In these tests, cement content was set at or below 4.0% weight based on total weight of powders, which is below any type of cementing blends available in the market as of the time of this writing. Inventive Examples 9 to 13 involved the use of Sodium Naphthalene Sulfonate Formaldehyde Condensate as high range water reducer. Test results are shown in Tables 4.

In Inventive Example 11 (table 4), involving the introduction of quick lime into the mix, when compared the results of Test 9, there was an increment of 1.9 MPa that was noticeable in terms of 24 hours compressive strength; and this represented an increase of 22%. The increase in compressive strength approached 25% in the case of the compressive strength at 28 days.

In Inventive Examples 12; 13 and 14 (table 4), mixtures in which were added quick lime, hydrated lime and limestone fillers were compared at same additional rate in a mix at a water to binder ratio of 0.37. Adding these materials obtained certain advantages. The quick lime appeared to contribute the most in enhancing compressive strength at 7 and 28 days; however, there was a 4 degree Celsius increase in temperature of the mix after 10 minutes from the start of mixing. Hydrated lime and limestone filler were comparable.

Table 4 below describes sample compositions that comprise two different amounts of GGBFS and also contain naphthalene sulfonate.

TABLE 4

| | Inventive | Inventive | Inventive | Inventive | Inventive | Inventive |
|---|---|---|---|---|---|---|
| Component | Example 9 | Example 10 | Example 11 | Example 12 | Example 13 | Example 14 |
| GGBFS I, grams | 672 | — | — | — | — | — |
| GGBFS II, grams | — | 672 | 672 | 622 | 622 | 622 |
| CEN Sand, grams | 1350 | 1350 | 1300 | 1350 | 1350 | 1350 |
| Water/Binder ratio | 0.34 | 0.34 | 0.34 | 0.37 | 0.37 | 0.37 |
| NSFC, % solids by | 0.27 | 0.27 | 0.4 | 0.44 | 0.44 | 0.36 |
| weight of binder | | | | | | |
| CEM \| 42.5R, grams | 28 | 28 | 28 | 28 | 28 | 28 |
| Secondary Activator, % | — | 2.32 | — | — | — | — |
| wt solids binder | | | | | | |
| NaCl % wt solids binder | 2.31 | — | 2.31 | 2.49 | 2.49 | 2.49 |
| Quick Lime, grams | — | — | 50 | 50 | — | — |
| Hydrated Lime, grams | — | — | — | — | 50 | — |
| Limestone Filler, grams | — | — | — | — | — | 50 |
| Flow (mm) | 180 | 140 | 105 | 120 | 130 | 175 |
| Density, kg/m³ | — | 2257 | 2250 | 2252 | 2243 | 2275 |
| Compressive Strength, | 8.3 | 7.5 | 10.3 | 8.6 | 7.3 | 7.8 |
| 1 day, MPa | | | | | | |
| Compressive Strength, | 8.6 | 7.7 | 10.5 | — | — | — |
| 1 day, MPa | | | | | | |
| Compressive Strength, | 12.9 | 14.5 | 21.9 | — | — | — |
| 2 days, MPa | | | | | | |
| Compressive Strength, | 12.5 | 14.8 | 22.1 | — | — | — |
| 2 days, MPa | | | | | | |
| Compressive Strength, | 20.6 | 23.2 | 34.0 | 31.9 | 27.7 | 26.0 |
| 7 days, MPa | | | | | | |
| Compressive Strength, | 21.7 | 22.40 | 32.8 | — | — | — |
| 7 days, MPa | | | | | | |
| Compressive Strength, | 36.9 | 32.0 | 45.1 | 45.1 | 41.1 | 40.8 |
| 28 days, MPa | | | | | | |
| Compressive Strength, | 36.3 | 32.4 | 46.4 | — | — | — |
| 28 days, MPa | | | | | | |
| Ambient Temperature | — | — | 22.3° C. | 23.6° C. | 23.6° C. | 23.6° C. |
| Mortar Temperature | — | — | 27.2 C. | 28° C. | 24.9° C. | 23.9° C. |
| (10 minutes) | | | | | | |

### Inventive Examples 15-17

The same mixing procedure used for Comparative Examples 1-4 was used, except the material amounts of Table 5 were used. Inventive Examples 15 to 17 involved the use of Sodium Naphthalene Sulfonate Formaldehyde Condensate as high range water reducer

In Inventive Examples 15, 16 and 17 (table 5), the performance of mortar sample that incorporated quick lime was checked at ratios of quick lime, namely, 2.0, 4.0 and 6.0% weight based on total weight of the powder materials. As seen in Inventive Examples 16 and 17, there did not appear to be a large difference between 4.0% and 6.0%, except that the temperature of the mix was higher after 10 minutes from the initiation of mixing at the higher percentage ratio (6.0%). A ratio of 5.0% was chosen for the remaining trials as described hereinafter.

TABLE 5

| | Test 15 | Test 16 | Test 17 |
|---|---|---|---|
| | with | with | with |
| Component | quick lime | quick lime | quick lime |
| GGBFS II, grams | 658 | 644 | 630 |
| CEN Sand, grams | 1350 | 1350 | 1350 |
| Water/Binder ratio | 0.35 | 0.357 | 0.365 |
| NSFC, % solids by weight of | 0.35 | 0.39 | 0.43 |
| binder | | | |
| CEM \| 42.5R, grams | 28 | 28 | 28 |
| NaCl % wt solids binder | 2.36 | 2.41 | 2.46 |
| Quick Lime, grams | 14 | 28 | 42 |
| Flow, mm | 150 | 145 | 130 |
| Density, kg/m3 | 2265 | 2261 | 2260 |
| Compressive Strength, 24 | 7.3 | 8.2 | 8.6 |
| hours, MPa | | | |
| Compressive Strength, 7 days, | 29.4 | 31.8 | 24.2 |
| MPa | | | |
| Compressive Strength, 28 days, | 42.6 | 45.3 | 44.9 |
| MPa | | | |
| Ambient Temperature | 22.6 C. | 22.6 C. | 22.6 C. |
| Mortar Temperature (10 | 24.9 C. | 25.9 C. | 28 C. |
| minutes) | | | |

### Inventive Examples 18-21

The same mixing procedure used for Comparative Examples 1-4 was used, except the material amounts of Table 6 were used. Further tests were done using polycarboxylate (“PC”) type high range water reducer admixtures, and Inventive Examples 18, 19, 20, and 21 are shown in Table 6 below. In Inventive Example 18, the use of PC-based admixture was believed to enhance compressive strength of the samples because compressive strength was found to be 10.5 MPa at 24 hours and 40.6 MPa at 28 days.

In Inventive Example 19, a combination of PC-based admixture, chloride-based activator, quick lime and limestone filler were used in the sample at a water-to-binder ratio of 0.34, and compressive strength was measured as 23.0 MPa at 24 hours and 50.7 MPa at 28 days.

In Inventive Example 20, the water to binder ratio was reduced to 0.28 using the same combination of components as in Inventive Example 19. Compressive strength was measured as increasing to 34.4 MPa at 24 hours and 69.1 MPa at 28 days.

Inventive Example 21 was essentially a repeat of Inventive Example 19, except that a non-chloride-based activator was used. Compressive strength was measured as 20.8 MPa at 24 hours and 47.3 MPa at 28 days.

In the exemplary embodiments shown in the table below, GGBFS was tested in combination with polycarboxylate ether (“PC”) polymer type water-reducing admixtures and quick lime.

TABLE 6

| | Inventive | Inventive | Inventive | Inventive |
|---|---|---|---|---|
| | Example | Example | Example | Example |
| Component | 18 | 19 | 20 | 21 |
| GGBFS III, grams | 672 | 672 | 742 | 672 |
| CEN Sand, grams | 1350 | 1250 | 1250 | 1250 |
| Water/Binder ratio | 0.34 | 0.34 | 0.28 | 0.34 |
| Polycarboxylate, % solids by weight of binder | 0.036 | 0.082 | 0.16 | 0.11 |
| CEM \| 42.5R, grams | 28 | 28 | 28 | 28 |
| Secondary Activator, % wt solids binder | — | — | — | 2.32 |
| NaCl, % wt solids binder | 2.31 | 2.31 | 2.1 | — |
| Quick Lime, grams | — | 50 | 50 | 50 |
| Limestone Filler, grams | — | 50 | 50 | 50 |
| Flow, mm | 180 | 160 | 160 | 180 |
| Density, kg/m3 | 2280 | 2274 | 2323 | 2286 |
| Compressive Strength, 24 hours, MPa | 10.5 | 23.0 | 34.4 | 20.8 |
| Compressive Strength, 7 days, MPa | 31.4 | 45.0 | 60.3 | 41.5 |
| Compressive Strength, 28 days, MPa | 40.6 | 50.7 | 69.1 | 47.3 |
| Ambient Temperature | 22.2 C. | 24.2 C. | 24.2 C. | — |
| Mortar Temperature (10 minutes) | 22.5 C. | 28.6 C. | 29.7 C. | 30.5 C. |

### Inventive Example 22

The mixing procedure for concrete was as follows: (i) weighed 20 mm aggregates, 10 mm aggregates, crushed sand, dune sand all materials in powder forms (GGBFS, Lime, fillers, etc.); (ii) weighed required water (depending on the experiment); (iii) weighed dispersant and activator; (iv) loaded aggregates and sand into the mixer and started mixing while adding 25% of the water during 30 seconds; (iv) added powder materials to the aggregates and mixed for 30 seconds while adding remaining water; (v) added admixtures to the mix and continued mixing for an additional 2 minutes. In total, this mixing procedure took 3 minutes. During preparation, mixing and testing, materials and concrete were kept at a temperature of 24.0° C.±2.0° C.

In Inventive Example 22, a concrete trial was conducted in a GGBFS mix with a content of 4% CEM I, 5% quick lime and 5% limestone filler. It used a non-chloride-based activator and a PC based dispersant. 2 specimens were cured at 45 degrees Celsius for the first 24 hours and tested for compressive strength after 24 hours and 28 days. Results are shown in Table 7.

As summarized in Table 7 below, an exemplary cementitious composition was made by blending about 4% by weight cement into the slag-based composition, along with aggregates, to make an exemplary concrete.

TABLE 7

| | Inventive |
|---|---|
| Component | Example 22 |
| GGBFS I, kg | 433 |
| Water/Binder ratio | 0.28 |
| Polycarboxylate (PC), % solids by weight of binder | 0.27 |
| CEM \| 42.5R, kg | 18 |
| 20 mm Aggregate, kg | 715 |
| 10 mm Aggregate, kg | 251 |
| 5 mm CS, kg | 520 |
| Dune Sand, kg | 363 |
| Secondary Activator, % wt solids binder | 2.31 |
| Quick Lime (calcium oxide), kg | 22.5 |
| Limestone Filler, kg | 22.5 |
| Flow, mm | 660 |
| Density, kg/m3 | 2450 |
| Compressive Strength, 24 hours, MPa | 23.3 |
| Compressive Strength, 24 hours, MPa | |
| First 24 h curing at 45 C. | 34.3 |
| Compressive Strength, 7 days, MPa | 47.6 |
| Compressive Strength, 28 days, MPa | 53.8 |
| Compressive Strength, 28 days, MPa | |
| First 24 hours curing at 45 C. | 51.7 |
| Concrete temperature after 10 min from mixing | 28.3 C. |

The early age compressive strength attained at 24 hours was tested and found to be 23.3 MPa and the 28 days compressive strength was tested and found to be 53.8 MPa.

It was also found that curing the sample at moderately high temperature improved the compressive strength at 24 hours by more than 47.0% up to 34.3 MPa. It was also found that strength at 28 days was not much affected.

### Inventive Examples 23, 24 and 25

This section is based on mixes containing 100% GGBFS and shows the activation of GGBFS from several different sources with the proposed tools and additives. The same mixing procedure used for Comparative Examples 1-4 was used, except the material amounts of Table 8 were used.

In Inventive Example 23, 24 and 25, different sources of GGBFS were tested for efficiency of their activation in mortar mixes using PC-type dispersant admixture, a secondary activator, quick lime (calcium oxide) and limestone filler. Depending on the composition, it was determined that each type of GGBFS can behave differently, depending upon the nature or demands of the PC dispersant in regard to early age compressive strength. All types showed improved compressive strength at 24 hours, as shown in Table 8 below.

In Inventive Example 23, average compressive strength was found to be 8.9 MPa at 24 hours, and, in test 24, it was found to be 19.5 MPa at 24 hours results.

In Inventive Example 25, average compressive strength was found impossible to measure before 39 hours, but at 39 hours it was found to be 31.4 MPa.

TABLE 8

| | Inventive | Inventive | Inventive |
|---|---|---|---|
| | Example | Example | Example |
| Components | 23 | 24 | 25 |
| GGBFS III, grams | 770 | — | — |
| GGBFS IV, grams | — | 770 | — |
| GGBFS V, grams | — | — | 770 |
| CEN Sand, grams | 1250 | 1250 | 1250 |
| Water/Binder ratio | 0.28 | 0.28 | 0.28 |
| Polycarboxylate (PC), % solids by | 0.19 | 0.51 | 0.42 |
| weight of binder | | | |
| Secondary Activator, % wt solids | 2.1 | 2.1 | 2.1 |
| binder | | | |
| Quick Lime (calcium oxide), grams | 50 | 50 | 50 |
| Limestone Filler, grams | 50 | 50 | 50 |
| Flow, mm | 210 | 295 | 320 |
| Density, kg/m3 | 2312 | 2336 | — |
| Compressive Strength, 24 hours, MPa | 8.9 | 19.5 | 31.4 |
| Compressive Strength, 3 days, MPa | 46.6 | — | — |
| Compressive Strength, 7 days, MPa | 54.1 | — | 42.7 |
| Compressive Strength, 28 days, MPa | — | 55.3 | — |
| Ambient Temperature | 22.3° C. | 22.9° C. | 22.7° C. |
| Mortar Temperature (at 10 minutes) | 28.3° C. | 28.8° C. | 26.9° C. |

### Inventive Examples 26-30

The procedure used for Inventive Example 22 was used, except the amounts are those listed in Table 9.

From Table 9, in Inventive Example 26, 459 kg of GGBFS were used alone at a water to cement ratio of 0.34, in combination with a polycarboxyate ether (PC) type polymer dispersant, a non-chloride activator, and quick lime. The compressive strength at 24 hours was 14.8 MPa and 31.8 MPa when the specimen was cured at 35 degrees Celsius. At 28 days, compressive strength reached 63.8 and 70.7 MPa, respectively.

In Inventive Examples 27, 28 and 29, different types of GGBFS were used at a water-to-binder ratio of 0.34 in combination with a PC type dispersant and another PC type dispersant (“PC-2”), a non-chloride activator, quick lime (2.5%), and hydrated lime (2.5%). Compressive strength results at 24 hours were higher than 10 MPa and reaching 17.9 MPa. Curing at 35 degrees Celsius improved remarkably the results at 24 hours and up to 69%. The ultimate strength results at 42 days were comparable for all three types of GGBFS for the specimens cured at ambient temperature and the one cured at 35 degrees Celsius for the first 24 hours.

In Inventive Example 30, a different mix design was used based on 434 kg GGBFS at a water to cement ratio of 0.38 and using an exemplary combination of two polycarboxylate ether (PC) type polymer dispersants (designated PC and PC-2), a non-chloride activator, quick lime (2.5%) and hydrated lime (2.5%). Compressive strength was 7 MPa for the specimen cured at ambient temperature and 14.8 MPa for the one cured at 35 degrees Celsius for the first 24 hours. At 42 days, compressive strength measured 46.1 MPa and 48.8 MPa respectively. As concrete producers sometimes employ two PC polymers, one PC which enhances slump initially, and a second PC which is intended to retain slump over time, the inventors wanted to test the effect of using more than one PC polymer in their example tests of slag-based materials according to the invention.

TABLE 9

| | Inventive | Inventive | Inventive | Inventive | Inventive |
|---|---|---|---|---|---|
| | Example | Example | Example | Example | Example |
| Components | 26 | 27 | 28 | 29 | 30 |
| GGBFS IV, kg | — | 459 | — | — | — |
| GGBFS V, kg | 459 | — | 459 | — | — |
| GGBFS VI, kg | — | — | — | 459 | 434 |
| 20 mm Agg., kg | 601 | 601 | 601 | 601 | 601 |
| 10 mm Agg., kg | 271 | 271 | 271 | 271 | 271 |
| 5 mm CS, kg | 581 | 581 | 581 | 581 | 581 |
| Dune Sand, kg | 372 | 372 | 372 | 372 | 372 |
| Water/Binder ratio | 0.34 | 0.34 | 0.34 | 0.34 | 0.38 |
| Secondary Activator, % wt solids | 2.31 | 2.31 | 2.31 | 2.31 | 2.31 |
| binder | | | | | |
| PC, % solids by weight of binder | 0.44 | 0.18 | 0.18 | 0.18 | 0.16 |
| PC-2, % solids by wt of binder | 0.16 | 0.16 | 0.16 | 0.16 | 1.17 |
| Quick Lime, kg | 23 | 11.5 | 11.5 | 11.5 | 10.85 |
| Hydrated Lime, kg | 0 | 11.5 | 11.5 | 11.5 | 10.85 |
| Ambient Temperature, ° C. | 22.5 | 22.5 | 22.5 | 22.9 | 23.4 |
| Concrete Temperature at 5′, ° C. | 28 | 25.1 | 25.1 | 26.1 | 25.3 |
| Slump/Flow at 5′, mm | 165 | 250/510 | 250/540 | 250/670 | 255/685 |
| Slump at 30′, mm | — | 180 | 160 | 220/330 | 235/405 |
| Density, kg/m3 | 2490 | 2440 | 2470 | 2480 | 2430 |
| Compressive Strength, 24 hrs, MPa | 14.8 | 10.1 | 17.9 | 13.1 | 7.0 |
| Compressive Strength, 24 hrs, MPa** | 31.8 | 14.9 | 30.3 | 19.8 | 14.8 |
| Compressive Strength, 7 days, MPa | 51.3 | 30.5 | 44.5 | 40.8 | 33.2 |
| Compressive Strength, 7 days, MPa** | 59.2 | 31.2 | 51.3 | 45.3 | 38.3 |
| Compressive Strength, 14 days, MPa | 54.3 | — | — | — | — |
| Compressive Strength, 14 days, MPa** | 60.9 | — | — | — | — |
| Compressive Strength, 21 days, MPa | — | 37.4 | 55.5 | — | — |
| Compressive Strength, 21 days, MPa** | — | 36 | 60 | — | — |
| Compressive Strength, 28 days, MPa | 63.8 | — | — | — | — |
| Compressive Strength, 28 days, MPa** | 70.7 | — | — | — | — |
| Compressive Strength, 42 days, MPa | — | 39.4 | 56.7 | 53.3 | 46.1 |
| Compressive Strength, 42 days, MPa** | — | 40.2 | 59.7 | 55.1 | 48.8 |

**specimen cured at 35 C. for the first 24 hours

The foregoing examples and exemplary embodiment details were presented for illustrative purposes and not intended to limit the scope of the invention.

It is claimed:

1. A method for making a cementitious composition, comprising: mixing together with water the following components:
(A) a cementitious binder composition comprising ground granulated blast furnace slag (GGBFS) in an amount of 71%-100% based on total dry weight of the cementitious binder component;
(B) at least one alkaline-earth activator chosen from Ca(OH)₂, CaO, MgO, or a mixture thereof; and
(C) an early strength enhancer component comprising (i) at least one slag dispersant chosen from a polycarboxylate ether (PC) type polymer dispersant, a non-PC dispersant chosen from a sulfonate type dispersant or a phosphonate type dispersant; and (ii) at least one activator chosen from calcium nitrate, calcium nitrite, calcium chloride, sodium chloride, triethanolamine, methyldiethanolamine, sodium thiocyanate, or mixture thereof.

2. The method of claim 1 wherein the early strength enhancer component comprises at least one PC type polymer dispersant, and more preferably at least two PC type polymer dispersants.

3. The method of claim 1 wherein the binder composition of component A further comprises fly ash, and further wherein the GGBFS:fly ash weight ratio in component A is from 71:29 to 95:5.

4. The method of claim 1 wherein the water and the components A, B, and C are mixed together in the following amounts: water in the amount of 25%-45%; component A comprising 71%-100% GGBFS based on total dry solid weight of the cementitious binder composition of component A; component B in the amount of 0.5% to 10%; and component C in the amount of 1.5% to 6.0%; the foregoing percentages of water and components A, B, and C being based on total dry weight of component A.

5. The method of claim 1 wherein the water and components A, B, and C are mixed together in the following amounts: water in the amount of 25%-40%; component A comprising 96%-100% GGBFS based on total dry solids weight of the cementitious binder composition of component A; component B in the amount of 2.0% to 8.0%; and component C in the amount of 2.0% to 5.0%; the foregoing percentages of water and components A, B, and C being based on total dry weight of component A.

6. The method of claim 1 wherein the water and components A, B, and C are mixed together in the following amounts: water in the amount of 28%-38%; component A comprising 100% GGBFS based on total dry solids weight of the cementitious binder composition of component A; component B in the amount of 4.0% to 6.0%; and component C in the amount of 2.5% to 4.5%; the foregoing percentages of water and components A, B, and C being based on total dry weight of component A.

7. The method of claim 1 wherein components B and C are combined together or combined separately with component A.

8. The method of claim 1 wherein, in addition to the at least one alkaline-earth activator component chosen from Ca(OH)₂, CaO, MgO, or a mixture thereof as set forth in component B, component A is combined with at least one activator chosen from calcium nitrate, calcium nitrite, sodium thiocyanate, triethanolamine, methyldiethanolamine, calcium chloride, sodium chloride, or mixture thereof.

9. The method of claim 9 wherein component A is combined with at least one activator chosen from calcium nitrate, calcium nitrite, or mixture thereof.

10. The method of claim 1 wherein component A is devoid of Ordinary Portland Cement, calcium sulfoaluminate cement, or mixture thereof.

11. The method of claim 1 wherein the strength enhancement component comprises at least one PC type dispersant polymer obtained from three monomer components A, B, and C, wherein monomer component A is an unsaturated carboxylic acid monomer represented by structural formula 1, 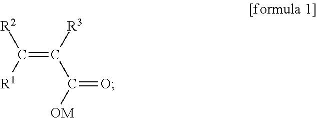
monomer component B is a polyoxyalkylene monomer represented by structural formula 2: 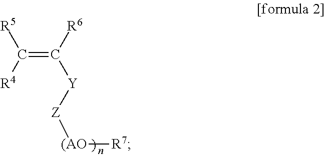
monomer component C is an unsaturated carboxylate ester or amide monomer represented by structural formula 3: 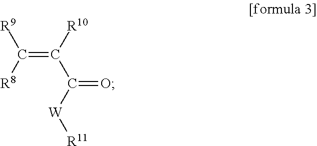
wherein R¹, R², R³, R⁴, R⁵, R⁶, R⁷, R⁸, R⁹, and R¹⁰ each individually represent a hydrogen atom, a C1 to C4 alkyl group, or —COOM group wherein M represents a hydrogen atom or an alkali metal; Y represents —(CH₂)ₚ— wherein “p” represents an integer of 0 to 6; Z represents —O—, —COO—, —OCO—, —COHN—, or —NHCO— group; -(AO)ₙ represents repeating ethylene oxide groups, propylene oxide groups, butylene oxide groups, or a mixture thereof; “n” represents the average number of repeating -(AO)-groups and is an integer of from 10 to 250; W represents an oxygen atom or an —NH— group, and R₁₁ represents a C1-C10 alkyl group or a C2-C10 hydroxyalkyl group.

12. The method of claim 13 wherein the early strength enhancement component comprises at least one polycarboxylate ether type dispersant polymer having at least two different structures using different component B monomers represented by formula 2.

13. The method of claim 12 wherein the early strength enhancement component comprises at least one polycarboxylate type comb polymers in combination with at least one viscosity modifying admixture, preferably chosen from a biopolymer polysaccharide, a cellulose type thickener, or mixture thereof.

14. The method of claim 1 wherein the at least one dispersant is sodium naphthalene sulfonate.

15. The method of claim 1 wherein component B further includes calcium carbonate or source of calcium carbonate, wherein the calcium carbonate is present in the binder of component A in the amount of 0.1 to 10% based on total dry weight of component A.

16. The method of claim 1 wherein, after mixing water and components A, B, and C together to obtain a uniform paste or slurry, the paste or slurry is subjected after mixing to a temperature of 30-70 degrees C.

17. A cementitious composition made according to the method of claim 1.

18. An admixture package for modifying a ground granulated blast furnace slag (GGBFS) binder composition, comprising:
(A) at least one alkaline-earth activator chosen from Ca(OH)₂, CaO, MgO, or a mixture thereof;
(B) an early strength enhancer component comprising (i) at least one slag dispersant chosen from a polycarboxylate ether (PC) type polymer dispersant, or a non-PC dispersant chosen from a sulfonate type dispersant or a phosphonate type dispersant; and (ii) at least one activator chosen from calcium nitrate, calcium nitrite, calcium chloride, sodium chloride, triethanolamine, methyldiethanolamine, sodium thiocyanate, or mixture thereof.
